(19) United States
(12) Patent Application Publication
(10) Pub. No.: US 2025/0113142 A1
(43) Pub. Date: Apr. 3, 2025

(54) SPEAKER

(71) Applicant: AAC Technologies (Nanjing) Co., Ltd., Nanjing (CN)

(72) Inventors: Yao Hui, Nanjing (CN); Weimin Chen, Nanjing (CN); Xingchi Chen, Nanjing (CN); Lei Zhao, Nanjing (CN); Yufen Chu, Nanjing (CN)

(21) Appl. No.: 18/522,166

(22) Filed: Nov. 28, 2023

Related U.S. Application Data
(63) Continuation of application No. PCT/CN2023/122772, filed on Sep. 28, 2023.

(51) Int. Cl. H04R 1/28; H04R 1/02; H04R 7/04; H04R 7/18; H04R 9/02; H04R 9/04; H04R 9/06

(52) U.S. Cl. CPC H04R 1/2896; H04R 1/025; H04R 1/288; H04R 7/04; H04R 7/18; H04R 9/025; H04R 9/045; H04R 9/06; H04R 2400/11

(57) ABSTRACT

The present disclosure discloses a speaker comprising a housing and a sound producing unit fixed to the housing; the sound producing unit comprises: a frame, a vibration system, a magnetic circuit system and a spring damping element; the spring damping element supports the magnetic circuit system in vibration in the holding space; a counterweight block housed in the rear cavity and fixed to a side of magnetic bowl away from the magnetic circuit system. The speaker of the present invention constitutes another vibration system by means of a magnet or a magnetic bowl and a spring damping element, which vibrates opposite to the vibration system consisting of a diaphragm-dome-voice coil, resulting in a reduction of the force on the cone frame; the addition of a counterweight block reduces the effect of air in the rear cavity on the magnet; the magnetic through-holes and leakage holes optimize vibration damping.

### FIELD OF THE PRESENT DISCLOSURE

The present disclosure relates to electro-acoustic transducers, especially relates to a speaker for electronic speaker products.

### DESCRIPTION OF RELATED ART

In recent years, the rapid development of information technology, the popularity of audio equipment is becoming more and more high, people's requirements for audio equipment is not only limited to the playback of video and audio, but also require the reliability of audio equipment to put forward more requirements, especially the arrival of the 5G era, the development of mobile multimedia technology has also been accompanied by the development of a lot of audio equipment with a variety of entertainment features, such as video playback, digital video camera, games, GPS navigation, etc., with the increasing demand for more and more functionality, the degree of integration of components within the more and more high, the quality of the product is also more and more stringent requirements.

In audio equipment, a speaker is a commonly used electronic component, which is mainly used for audio signal playback, and its structural design directly affects the quality of audio playback. Existing speakers include a frame, a magnetic circuit system and a vibration system that are housed in the frame. When the voice coil in the vibration system vibrates, the fixed boundary is subjected to a force, which is transmitted to the mobile terminal case, and in the vicinity of the resonance frequency or when the excitation voltage is large, the fixed boundary is susceptible to excessive force resulting in a pronounced shell vibration, which in turn affects the user experience.

Therefore, it is necessary to provide an improved speaker to overcome the problems mentioned above.

### SUMMARY OF THE INVENTION

The present disclosure provides a speaker that achieves optimum vibration damping with the entire sound producing unit in a closed housing.

The speaker comprising: a housing having a receiving space, a sound outlet extending through the housing and communicating with the receiving space, and a sound producing unit housed in the receiving space and fixed to the housing; the sound producing unit dividing the receiving space into a front cavity and a rear cavity, the front cavity being communicated with the sound outlet, and a sound producing side of the sound producing unit being oriented toward the sound outlet; wherein, the housing is further provided with a leakage hole through it, and the leakage hole being in connection with the rear cavity; the sound producing unit comprises: a frame fixed to the housing and having a holding space, a vibration system placed in the holding space and a magnetic circuit system for driving the vibration system to vibrate and sound, and a spring damping element resiliently connecting the magnetic circuit system to the frame; the vibration system comprises a diaphragm fixed to the frame at its outer periphery and a voice coil which drives the diaphragm to vibrate and sound; the magnetic circuit system is fixed to the frame and together with the frame and the vibration system encloses an inner acoustic cavity, the magnetic circuit system being provided with a magnetic gap, the voice coil being fixed to the diaphragm and being inserted into the magnetic gap; the magnetic circuit system is further provided with a magnetic through-hole, the magnetic through-hole connects the inner acoustic cavity with the rear cavity; the spring damping element supports the magnetic circuit system in vibration in the holding space.

Further, wherein the magnetic circuit system comprises a magnetic bowl, a magnet fixed to the magnetic bowl, and a pole core superimposed on a side of the magnet proximate to the diaphragm; the magnetic bowl comprising a bottom wall of the magnetic bowl and a side wall extending in a curved manner from a peripheral side of the bottom wall of the magnetic bowl; the magnet being spaced from the side wall and forming the magnetic gap; and the spring damping element being fixedly coupled to either the side wall or the bottom wall of the magnetic bowl.

Further, wherein the magnetic through-hole includes a first magnetic through-hole through the pole core, a second magnetic through-hole through the magnet, and a third magnetic through-hole through the bottom wall of the magnetic bowl.

Further, wherein the first magnetic through-hole is provided orthogonally to the second magnetic through-hole, and the second magnetic through-hole is provided orthogonally to the third magnetic through-hole.

Further, wherein the sound producing unit further comprises a counterweight block housed in the rear cavity and fixed to the magnetic circuit system.

Further, wherein the counterweight block is affixed to opposite sides of the bottom wall of the magnetic bowl proximate to one side of the rear cavity, or is affixed to the geometric center of the bottom wall of the magnetic bowl, or is affixed around the circumference of the bottom wall of the magnetic bowl.

Further, wherein the counterweight blocks comprise two, the two counterweight blocks are respectively fixed to the side of the bottom wall of the magnetic bowl away from the magnet and spaced apart, the two counterweight blocks being symmetrically disposed about a short axis of the bottom wall of the magnetic bowl.

Further, wherein the number of the magnetic through-hole is one through the geometric center of the magnetic circuit system or a plurality spaced apart from each other and through the magnetic circuit system.

Further, wherein the leakage hole is a tapered hole formed by stamping from one side proximate to the magnetic circuit system to one side remote from the magnetic circuit system or a groove with a through-hole formed by press-thinning.

Further, wherein the interior of the magnetic through-hole is filled with a low-flow-resistance sound-absorbing material.

Compared to related arts, the speaker of the present disclosure adds a spring damping element, the spring damping element connects the magnetic circuit system elastically to the frame and supports the vibration of the magnetic circuit system in the holding space, constituting another vibration system consisting of the magnet or the magnetic bowl and the spring damping element, which vibrates opposite to the vibration system consisting of the diaphragm, the dome, and the voice coil by an interaction force, making the frame subjected to a reduced force. Adding the counterweight block in the magnetic circuit system reduces the influence of air in the rear cavity on the magnets; the vibration damping effect is further optimized by adding the magnetic through-holes in the magnetic circuit system and optimizing the air action in the rear cavity through the leakage holes in the housing. The mass of the counterweight block and the stiffness and damping of the spring damping element can be adjusted to set the corresponding resonant frequency and damping of the magnetic circuit system to achieve the best vibration isolation effect.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is a structure schematic of a speaker of the present disclosure.

FIG. 2 is an exploded view of the speaker of the present disclosure.

FIG. 3 is a structure schematic of a spring damping element of the speaker of the present disclosure.

FIG. 4 is a cross-sectional view taken along line A-A in FIG. 1.

FIG. 5 is a cross-sectional view taken along line B-B in FIG. 1.

FIG. 6 is a structure schematic of a magnetic bowl of the present disclosure.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

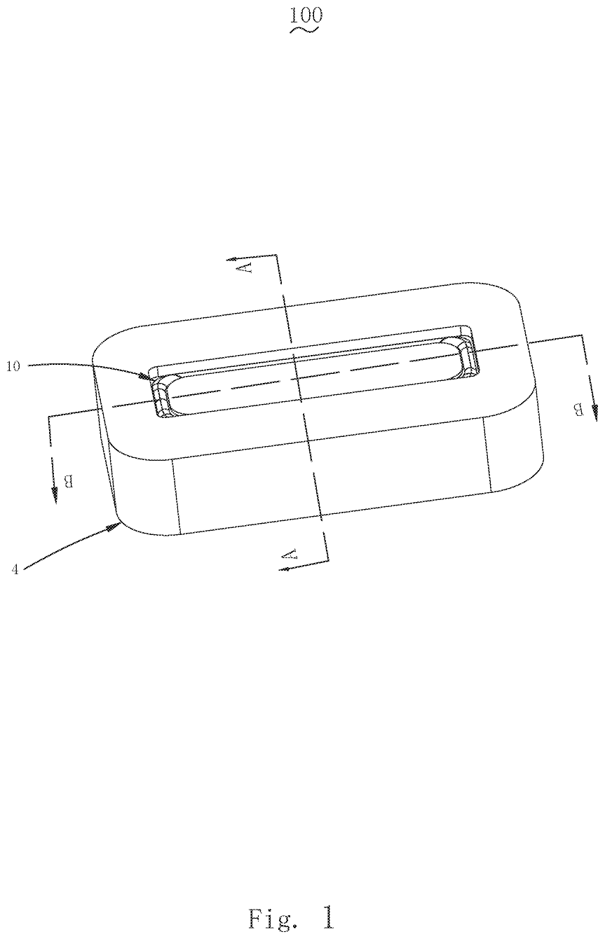

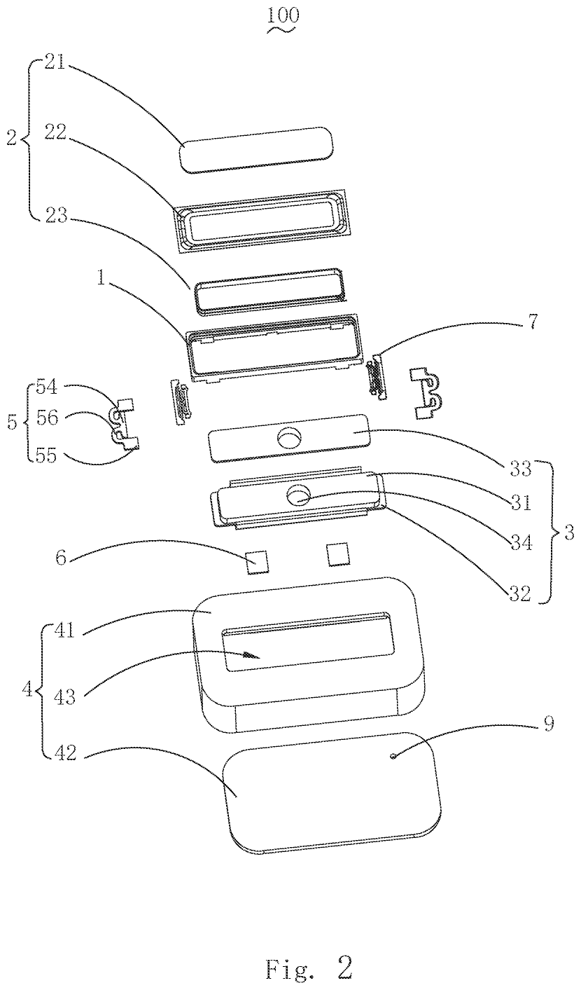

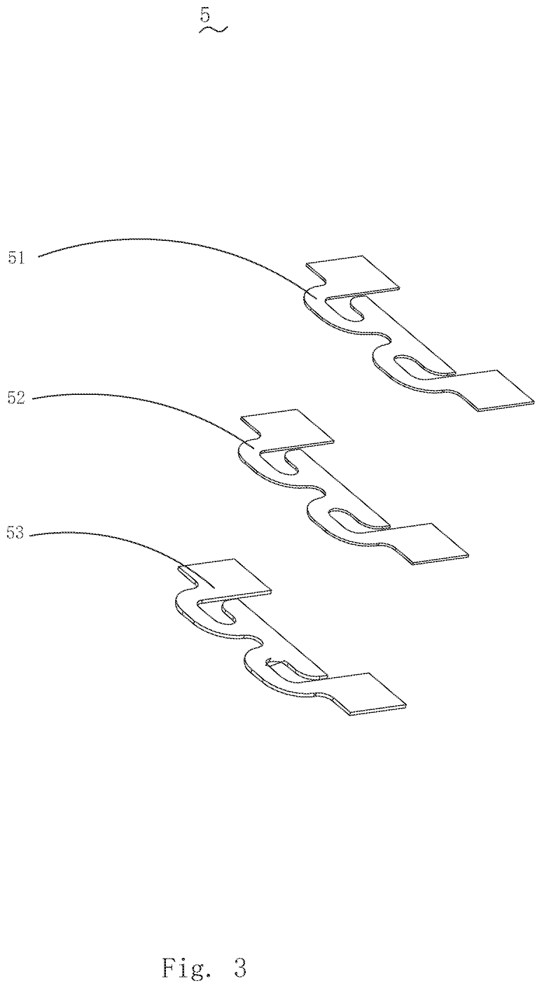

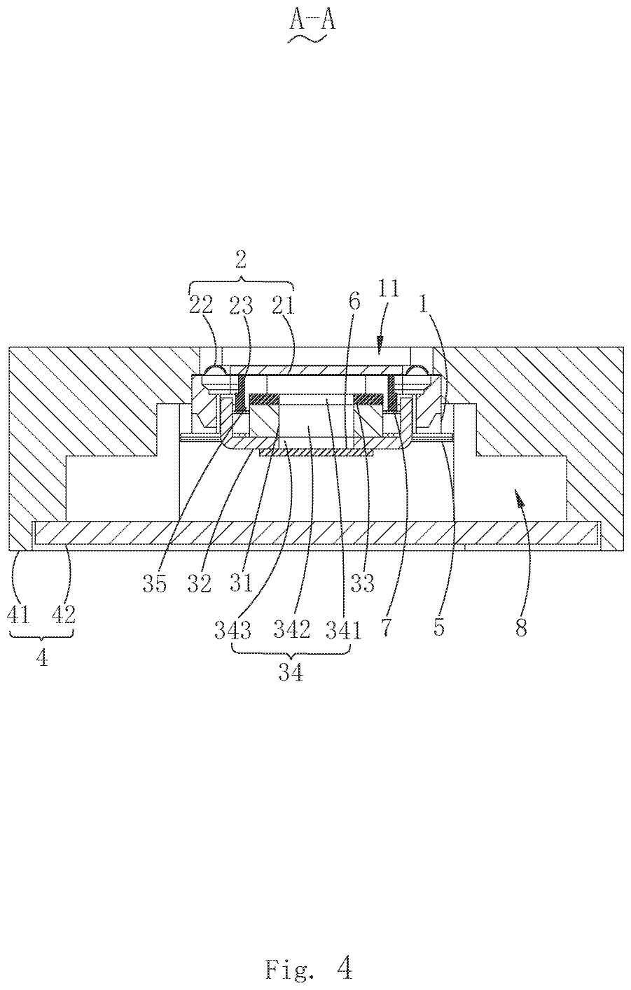

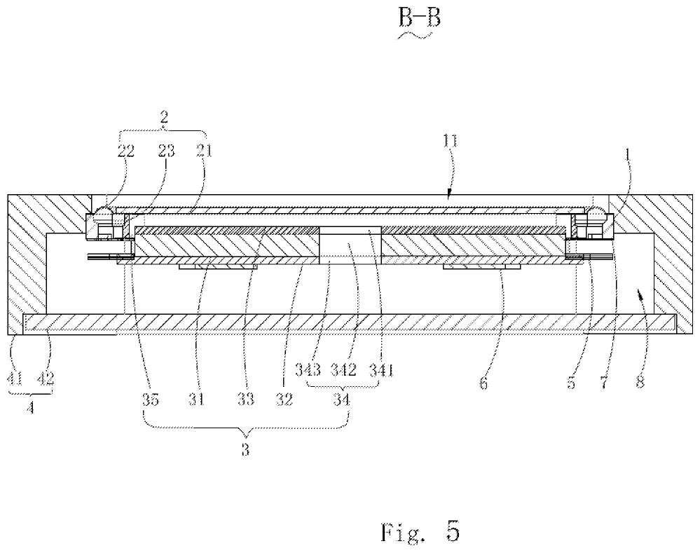

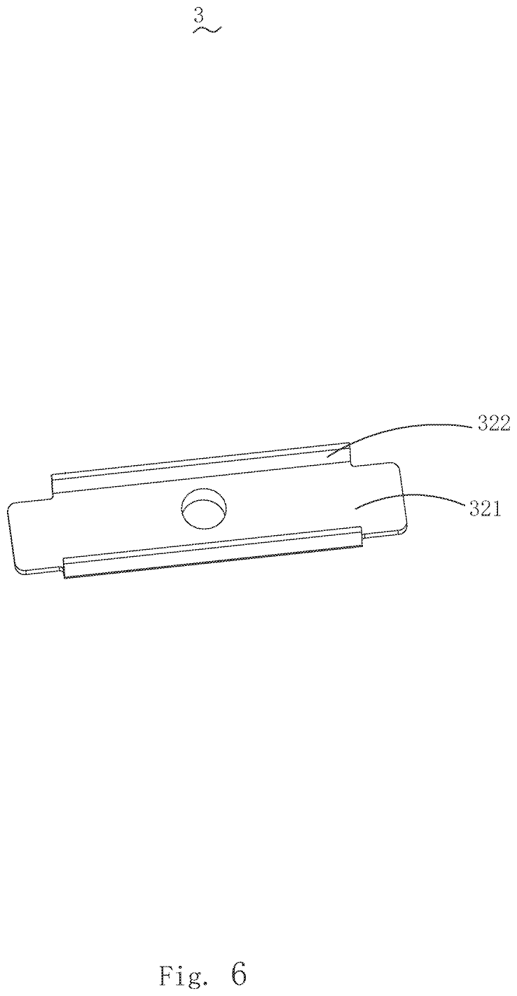

Please refer to FIGS. 1-6 together, the present disclosure providing a speaker 100 comprising: a housing 4 having a receiving space, a sound outlet 43 extending through the housing 4 and communicating with the receiving space, and a sound producing unit 10 housed in the receiving space and fixed to the housing 4; the sound producing unit 10 dividing the receiving space into a front cavity 11 and a rear cavity 8, the front cavity 11 being communicated with the sound outlet 43, and a sound producing side of the sound producing unit 10 being oriented toward the sound outlet 43. The housing 4 is further provided with a leakage hole 9 through it, and the leakage hole 9 being in connection with the rear cavity 8. The sound producing unit 10 comprises: a frame 1, a vibration system 2, a magnetic circuit system 3, a spring damping element 5, a counterweight block 6 and an elastic support component 7.

Among them, the frame 1 is fixed to the housing 4 and has a holding space, the vibration system 2 and the magnetic circuit system 3 are placed in the holding space, and the magnetic circuit system 3 is used for driving the vibration system 2 to vibrate and sound. The vibration system 2 comprises a diaphragm 22 fixed to the frame 1 at its outer periphery and a voice coil 23 which drives the diaphragm 22 to vibrate and sound.

In this embodiment, the vibration system 2 further comprises a dome 21 capped on the surface of the diaphragm 22.

In this embodiment, the magnetic circuit system 3 comprises a magnetic bowl 32 fixed to the frame 1, a magnet 31 fixed to the magnetic bowl 32, and a pole core 33 superimposed on a side of the magnet 31 proximate to the diaphragm 22; the magnetic bowl 32 comprising a bottom wall 321 of the magnetic bowl 32 and a side wall 322 extending in a curved manner from a peripheral side of the bottom wall 321 of the magnetic bowl 32; the magnet 31 is spaced from the side wall 322 and forming the magnetic gap 35; the voice coil 23 is fixed to the diaphragm 22 and is inserted into the magnetic gap 35; and the spring damping element 5 is fixedly coupled to either the side wall 322 or the bottom wall 321 of the magnetic bowl 32.

In this embodiment, the magnetic circuit system 3 is fixed to the frame 1 and together with the frame 1 and the vibration system 2 encloses an inner acoustic cavity.

In this embodiment, the magnetic circuit system 3 is further provided with a magnetic through-hole 34, the magnetic through-hole 34 connects the inner acoustic cavity with the rear cavity 8. The number of the magnetic through-hole 34 is one through the geometric center of the magnetic circuit system 3 or a plurality spaced apart from each other and through the magnetic circuit system 3.

In this embodiment, the magnetic through-hole 34 includes a first magnetic through-hole 341 through the pole core 33, a second magnetic through-hole 342 through the magnet 31, and a third magnetic through-hole 343 through the bottom wall 321 of the magnetic bowl 32. The first magnetic through-hole 341 is provided orthogonally to the second magnetic through-hole 342, and the second magnetic through-hole 342 is provided orthogonally to the third magnetic through-hole 343.

In this embodiment, the interior of the magnetic through-hole 34 is filled with a low-flow-resistance sound-absorbing material to enable fine tuning of air damping.

In this embodiment, the housing 4 further comprises a lower cover 42 and an upper cover 41 capped and secured to the lower cover 42, the sound outlet 43 is provided in the upper cover 41, the sound producing unit 10 is supported in the upper cover 41, and the sound producing unit 10, the upper cover 41, and the lower cover 42 collectively enclose the rear cavity 8.

In this embodiment, the lower cover 42 has the leakage hole 9 running through it. The leakage hole 9 is a tapered hole formed by stamping from one side proximate to the magnetic circuit system 3 to one side remote from the magnetic circuit system 3 or a groove with a through-hole formed by press-thinning. This structure reduces the equivalent air duct length to optimize the rear cavity air action.

In this embodiment, the spring damping element 5 elastically connects the magnetic circuit system 3 to the frame 1, and the spring damping element 5 supports the magnetic circuit system 3 to vibrate in the holding space; the spring damping element 5 and the magnet 31 or the magnetic bowl 32 form another vibration system in addition to the vibration system 2, which vibrates opposite to the vibration system 2 consisting of the diaphragm 22, the dome 21, and the voice coil 23, which are subjected to the interaction forces, causing the force on the frame 1 to be reduced. The damping effect can be optimized by tuning the stiffness and damping of the spring damping element 5.

In this embodiment, the spring damping element 5 comprises a first stiffness layer 51, a damping layer 52 superimposed and fixed to the first stiffness layer 51, and a second stiffness layer 53 superimposed and fixed to the damping layer 52. It is to be noted that the structure of the spring damping element 5 is not limited to three layers, but can be a similar multilayered sandwich structure realized in accordance with the above-described structure, which is feasible, and which has the same principle.

In this embodiment, the spring damping element 5 is made of one or more of a monolithic high damping material (e.g., damping rubber, foaming cotton, etc.), a polymer composite high damping material (e.g., a particle-reinforced fiber-reinforced and laminating composite material), and a metal composite damping structure (e.g., a high damping metal, a constrained layer damping structure, etc.).

In this embodiment, the spring damping element 5 comprises two, the two spring damping elements 5 are located on opposite sides of the short axis of the magnetic bowl 32 or on opposite sides of the long axis of the magnetic bowl 32.

In this embodiment, the spring damping element 5 comprises an inner fixing portion 54 secured to the side of the bottom wall 321 of the magnetic bowl near the diaphragm 22, an outer fixing portion 55 secured to the bottom of the frame 1, and an elastic arm 56 connecting the inner fixing portion 54 and the outer fixing portion 55.

In this embodiment, the counterweight block 6 is fixed to the side of the magnetic bowl 32 away from the vibration system 2; the counterweight block 6 effectively reduces the influence of the air in the rear cavity 8 on the magnet steel 31. It is also possible to partially cut down the magnets 31 and soft magnets, with the cut down portion being replaced by the counterweight block 6, in order to achieve a basically consistent base shape.

In this embodiment, the counterweight block 6 is affixed to opposite sides of the bottom wall 321 of the magnetic bowl 32 proximate to one side of the rear cavity 8, or is affixed to the geometric center of the bottom wall 321 of the magnetic bowl 32, or is affixed around the circumference of the bottom wall 321 of the magnetic bowl 32.

In this embodiment, two spring damping elements 5 are located on opposite sides of the short axis of the magnetic bowl 32, respectively. The counterweight blocks 6 comprise two, the two counterweight blocks 6 are respectively fixed to the side of the bottom wall 321 of the magnetic bowl 32 away from the magnet 31 and spaced apart, the two counterweight blocks 6 being symmetrically disposed about a short axis of the bottom wall 321 of the magnetic bowl 32.

In this embodiment, the elastic support component 7 is provided in the space on opposite sides of the short axis side of the frame 1, and one end of the elastic support component 7 is fixed to the frame 1, and the other end is fixed to the voice coil 23. The elastic support component 7 is used to strengthen the vibration effect of the diaphragm 22 on the one hand to improve the acoustic performance of the speaker 100, and on the other hand, it is used to balance the swaying of the vibration system 2 to improve the stability of the speaker 100.

Compared to related arts, the speaker of the present disclosure adds a spring damping element, the spring damping element connects the magnetic circuit system elastically to the frame and supports the vibration of the magnetic circuit system in the holding space, constituting another vibration system consisting of the magnet or the magnetic bowl and the spring damping element, which vibrates opposite to the vibration system consisting of the diaphragm, the dome, and the voice coil by an interaction force, making the frame subjected to a reduced force. Adding the counterweight block in the magnetic circuit system reduces the influence of air in the rear cavity on the magnets; the vibration damping effect is further optimized by adding the magnetic through-holes in the magnetic circuit system and optimizing the air action in the rear cavity through the leakage holes in the housing. The mass of the counterweight block and the stiffness and damping of the spring damping element can be adjusted to set the corresponding resonant frequency and damping of the magnetic circuit system to achieve the best vibration isolation effect.

It should be noted that if other sound generating methods are used but the sound producing unit is the dual vibration system designed in the present disclosure, it still belongs to the scope of the requirements of this disclosure; the rear cavity of the present disclosure is set on the side of the sound producing unit, and if the design of the other rear cavity structure as well as the filling of various types of acoustic materials but the sound producing unit is the dual vibration system designed in the present disclosure, it still belongs to the scope of the requirements of the present disclosure; if the structure of the module is different from the structure demonstrated in the present disclosure but the sound producing unit is the dual vibration system designed in the present disclosure, it still belongs to the scope of the requirements of the present disclosure.

The connection of the assembly process of the present disclosure is mainly glued, if other connection methods are used but the monobloc is the double vibration system designed by the present disclosure, it still falls within the scope of the claims of this disclosure.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker comprising: a housing having a receiving space, a sound outlet extending through the housing and communicating with the receiving space, and a sound producing unit housed in the receiving space and fixed to the housing; the sound producing unit dividing the receiving space into a front cavity and a rear cavity, the front cavity being communicated with the sound outlet, and a sound producing side of the sound producing unit being oriented toward the sound outlet; wherein, the housing is further provided with a leakage hole through it, and the leakage hole being in connection with the rear cavity; the sound producing unit comprises:
a frame fixed to the housing and having a holding space, a vibration system placed in the holding space and a magnetic circuit system for driving the vibration system to vibrate and sound, and a spring damping element resiliently connecting the magnetic circuit system to the frame; the vibration system comprises a diaphragm fixed to the frame at its outer periphery and a voice coil which drives the diaphragm to vibrate and sound; the magnetic circuit system is fixed to the frame and together with the frame and the vibration system encloses an inner acoustic cavity, the magnetic circuit system being provided with a magnetic gap, the voice coil being fixed to the diaphragm and being inserted into the magnetic gap; the magnetic circuit system is further provided with a magnetic through-hole, the magnetic through-hole connects the inner acoustic cavity with the rear cavity;
the spring damping element supports the magnetic circuit system in vibration in the holding space.

2. The speaker as described in claim 1, wherein the magnetic circuit system comprises a magnetic bowl, a magnet fixed to the magnetic bowl, and a pole core superimposed on a side of the magnet proximate to the diaphragm; the magnetic bowl comprising a bottom wall of the magnetic bowl and a side wall extending in a curved manner from a peripheral side of the bottom wall of the magnetic bowl; the magnet being spaced from the side wall and forming the magnetic gap; and the spring damping element being fixedly coupled to either the side wall or the bottom wall of the magnetic bowl.

3. The speaker as described in claim 2, wherein the magnetic through-hole includes a first magnetic through-hole through the pole core, a second magnetic through-hole through the magnet, and a third magnetic through-hole through the bottom wall of the magnetic bowl.

4. The speaker as described in claim 3, wherein the first magnetic through-hole is provided orthogonally to the second magnetic through-hole, and the second magnetic through-hole is provided orthogonally to the third magnetic through-hole.

5. The speaker as described in claim 2, wherein the sound producing unit further comprises a counterweight block housed in the rear cavity and fixed to the magnetic circuit system.

6. The speaker as described in claim 5, wherein the counterweight block is affixed to opposite sides of the bottom wall of the magnetic bowl proximate to one side of the rear cavity, or is affixed to the geometric center of the bottom wall of the magnetic bowl, or is affixed around the circumference of the bottom wall of the magnetic bowl.

7. The speaker as described in claim 5, wherein the counterweight blocks comprise two, the two counterweight blocks are respectively fixed to the side of the bottom wall of the magnetic bowl away from the magnet and spaced apart, the two counterweight blocks being symmetrically disposed about a short axis of the bottom wall of the magnetic bowl.

8. The speaker as described in claim 1, wherein the number of the magnetic through-hole is one through the geometric center of the magnetic circuit system or a plurality spaced apart from each other and through the magnetic circuit system.

9. The speaker as described in claim 1, wherein the leakage hole is a tapered hole formed by stamping from one side proximate to the magnetic circuit system to one side remote from the magnetic circuit system or a groove with a through-hole formed by press-thinning.

10. The speaker as described in claim 1, wherein the interior of the magnetic through-hole is filled with a low-flow-resistance sound-absorbing material.
